(19) United States
(12) Patent Application Publication
(10) Pub. No.: US 2026/0044010 A1
(43) Pub. Date: Feb. 12, 2026

(54) NET-SHAPE MOLDED LENSES WITH INTEGRATION FEATURES

(71) Applicant: Applied Materials, Inc., Santa Clara, CA (US)

(72) Inventors: Daniel Robert ADEMA, Kitchener (CA); Neal RICKS, San Jose, CA (US); Darren IHMELS, Port Moody (CA); Kazuya DAITO, Milpitas, CA (US)

(21) Appl. No.: 19/288,671

(22) Filed: Aug. 1, 2025

Related U.S. Application Data
(60) Provisional application No. 63/680,411, filed on Aug. 7, 2024.
(60) Provisional application No. 63/702,911, filed on Oct. 3, 2024.

(51) Int. Cl. G02B 27/01; G02C 9/04

(52) U.S. Cl. CPC G02B 27/0176; G02C 9/04

(57) ABSTRACT

Embodiments includes an ophthalmic lens and a method of forming the ophthalmic lens, as shown and described herein. The ophthalmic lens includes a waveguide, world-side (WS) lens, a WS adhesive securing the WS lens to the waveguide, a WS air gap between the WS lens and the waveguide, an eye-side (ES) lens, an ES adhesive securing the ES lens to the waveguide, and an ES air gap between the ES lens and the waveguide. The WS adhesive has a WS thickness and the WS air gap has a WS air gap distance. The WS air gap distance is greater than the WS adhesive thickness. The ES adhesive having an ES thickness and the ES air gap has an ES air gap distance. The ES air gap distance is greater than the WS adhesive thickness.

### CROSS-REFERENCE TO RELATED APPLICATIONS

This application claims priority to U.S. Provisional Ser. No. 63/702,911, filed Oct. 3, 2024 and U.S. Provisional Ser. No. 63/680,411, filed Aug. 7, 2024, which are herein incorporated by reference in their entirety.

### BACKGROUND

### Field

Embodiments of the present disclosure generally relate to optical waveguides. More specifically, embodiments described herein provide for forming ophthalmic lenses with embedded waveguides.

### Description of the Related Art

Virtual reality is generally considered to be a computer-generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

Typically, lens-stack assemblies with plano-surface lenses have an air gap thickness that is set by the adhesive bond-line thickness. In order to ensure the total-internal-reflection (TIR) over the full range of environmental conditions, a larger air gap is needed. A larger adhesive bond-line thickness, however, may undermine the adhesive reliability. In addition, ophthalmic lenses are machined from blanks, and any blank edging/machining is a subtractive process, so only features that are below the blank surface can be achieved with edging.

Accordingly, there is a need for improved systems and methods of forming ophthalmic lens with embedded waveguides.

### SUMMARY

In one embodiment, an ophthalmic lens is disclosed. The ophthalmic lens includes a waveguide, world-side (WS) lens, a WS adhesive securing the WS lens to the waveguide, a WS air gap between the WS lens and the waveguide, an eye-side (ES) lens, an ES adhesive securing the ES lens to the waveguide, and an ES air gap between the ES lens and the waveguide. The WS adhesive has a WS thickness and the WS air gap has a WS air gap distance. The WS air gap distance is greater than the WS adhesive thickness. The ES adhesive having an ES thickness and the ES air gap has an ES air gap distance. The ES air gap distance is greater than the WS adhesive thickness.

In another embodiment, an ophthalmic lens is disclosed. The ophthalmic lens includes a waveguide comprising a plurality of optical devices, a world-side (WS) lens, a WS adhesive securing the WS lens to the waveguide, a WS air gap between the WS lens and the waveguide, an eye-side (ES) lens, an ES adhesive securing the ES lens to the waveguide, and an ES air gap between the ES lens and the waveguide. The WS adhesive has a WS adhesive thickness of about 50 microns to about 250 microns. The WS air gap has a WS air gap distance of about 50 microns to about 300 microns. The ES adhesive has an ES adhesive thickness of about 50 microns to about 250 microns and the ES air gap has an ES air gap distance of about 50 microns to about 300 microns.

In another embodiment, a method of forming an ophthalmic lens is disclosed, as shown and described herein. The method includes molding a world-side (WS) lens and an eye-side (ES) lens. A coating is formed around the WS lens and the ES lens to form a coated WS lens and a coated ES lens. The coated WS lens and the coated ES lens are machined to form a machined WS lens having a WS adhesion region and a machined ES lens having an ES adhesion region. The machined WS lens and the machined ES lens are secured to a waveguide at the WS adhesion region and the ES adhesion region.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a perspective, frontal view of a waveguide, according to embodiments.

FIG. 2A is a schematic, cross-sectional view of an ophthalmic lens including a waveguide, according to embodiments.

FIG. 2B is a schematic, cross-sectional view of a portion of the ophthalmic lens, according to embodiments.

FIG. 3A is a schematic, cross-sectional view of a molded ophthalmic lens including a waveguide, according to embodiments.

FIG. 3B is a schematic, cross-sectional view of a partially molded ophthalmic lens, according to embodiments.

FIG. 4A is a schematic, cross-sectional view of an outer standoff ophthalmic lens having outer standoffs, according to embodiments.

FIG. 4B is a schematic, cross-sectional view of an inner standoff ophthalmic lens having inner standoffs, according to embodiments.

FIG. 5A is a schematic, cross-sectional view of a centered standoff ophthalmic lens having centered standoffs, according to embodiments.

FIG. 5B is a schematic, cross-sectional view of the centered standoff ophthalmic at cut line A-A, according to embodiments.

FIG. 6A is a frontal view of a standoff ophthalmic lens, according to embodiments.

FIG. 6B is the standoff ophthalmic lens showing the travel path of a propagating light, according to embodiments.

FIG. 6C is the standoff ophthalmic lens disposed in a frame, according to embodiments.

FIG. 7A is a schematic, cross-sectional view of a textured ophthalmic lens, according to embodiments.

FIG. 7B is a schematic, cross-sectional view of the textured ophthalmic lens having radial features at cutline B-B, according to embodiments.

FIG. 7C is a schematic, cross-sectional view of the textured ophthalmic lens having circumferential features at cutline B-B, according to embodiments.

FIG. 7D is a schematic, cross-sectional view of the textured ophthalmic lens having roughened features at cutline B-B, according to embodiments.

FIG. 8 is a schematic, cross-sectional view of a multi-size gap ophthalmic lens, according to embodiments.

FIG. 9 is a schematic, cross-sectional view of a tapered adhesive ophthalmic lens, according to embodiments.

FIG. 10 is a schematic, cross-sectional view of a tapered adhesive ophthalmic lens, according to embodiments.

FIG. 11A is a schematic, frontal view of a datum ophthalmic lens having a plurality of datums, according to embodiments.

FIG. 11B is a schematic view of a portion of the datum ophthalmic lens having a first datum, according to embodiments.

FIG. 11C is a schematic view of a portion of the datum ophthalmic lens having a second datum, according to embodiments.

FIG. 12A is a schematic, cross-sectional view of an uncoated WS lens, according to embodiments.

FIG. 12B is a schematic, cross-sectional view of a coated WS lens, according to embodiments.

FIG. 12C is a schematic, cross-sectional view of a machined WS lens, according to embodiments.

FIG. 13A is a schematic, frontal view of a vented ophthalmic lens, according to embodiments.

FIG. 13B is a schematic, bottom view of the vented ophthalmic lens, according to embodiments.

FIG. 14 is a flow chart of a method 1400 of forming an ophthalmic lens, according to embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to optical waveguides. More specifically, embodiments described herein provide for forming ophthalmic lenses with embedded waveguides.

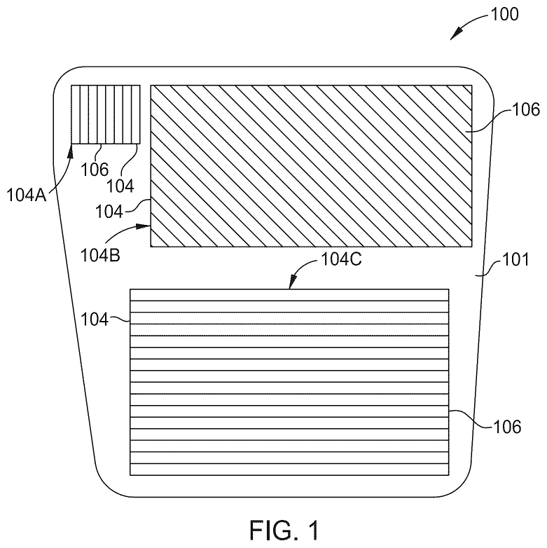

FIG. 1 is a frontal view of a waveguide 100. It is to be understood that the waveguide 100 described below is an exemplary waveguide. The waveguide 100 includes a substrate 101 and a plurality of optical devices 104. The plurality of optical devices 104 include an input coupling region 104A defined by a plurality of gratings 106, a waveguide region 104B, and an output coupling region 104C.

The input coupling region 104A receives incident beams of light (e.g., a light image) having an intensity from a micro-display. Each grating of the plurality of gratings 106 splits the incident beams into a plurality of modes. Zero-order mode (T₀) beams are refracted back or lost in the waveguide 100. Positive first order mode (T₁) beams undergo total-internal-reflection (TIR) through the waveguide 100 across the waveguide region 104B to the output coupling region 104C and output for display. Negative first-order mode (T₋₁) beams propagate in the waveguide 100 a direction opposite the T₁ beams. Among the diffracted orders, only the T₁ beams output to display through output coupling region 104C, while other modes are lost due to different directionality. Therefore, it is beneficial to increase T₁ beam intensity and decrease other orders beam intensity for higher device optical efficiency.

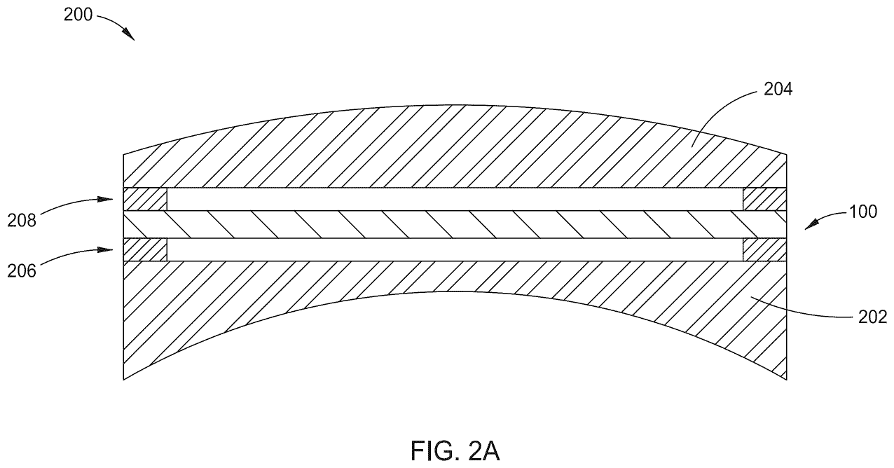

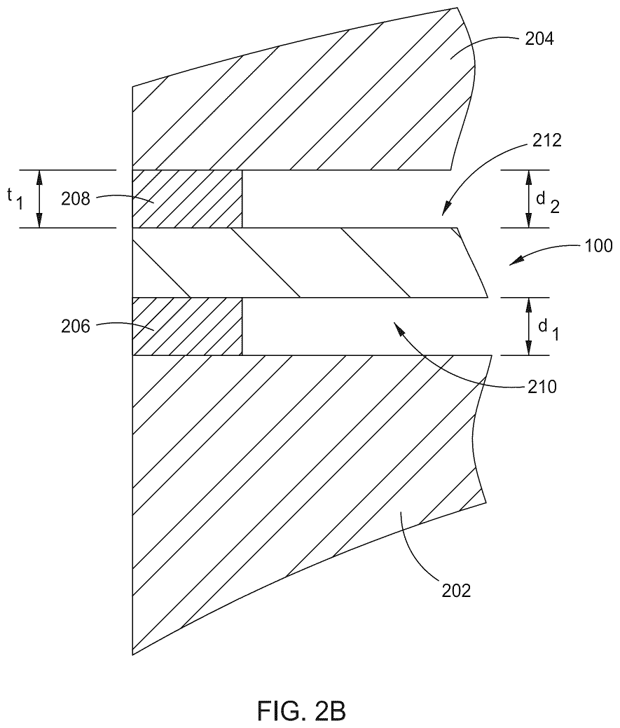

FIG. 2A is a schematic, cross-sectional view of an ophthalmic lens 200 including a waveguide 100. The ophthalmic lens 200 includes an eye side (ES) lens 202 and a world side (WS) lens 204. The waveguide 100 is disposed between the ES lens 202 and the WS lens 204. An eye side (ES) adhesive 206 secures the waveguide 100 to the ES lens 202 and a world side adhesive 208 secures the waveguide 100 to the WS lens 204.

Ophthalmic lenses are typically manufactured as round blanks (e.g., blank glass lenses without any features or prescriptions). The round blanks have diameters of about 50 mm to 80 mm, such as about 60 mm, such as about 65 mm, such as about 70 mm. The round blanks are machined (edged) to shape. Machine processing adds tolerance to the edge size. However, the machining process is limited, and machining is a subtractive process. Therefore, not all features can be easily achieved on the ophthalmic surfaces. In addition, when integrating the ophthalmic lenses into a lens stack with a waveguide, maintaining the adhesive bond line thickness can be a challenge. Cutting a typical spherical lens to an eyewear shape has an irregular offset to a planar waveguide. Therefore, using an ophthalmic lens having a plano surface requires an air gap between the lens and the waveguide to be equal to the adhesive thickness. Furthermore, locating the waveguide relative to the lenses can be challenging.

FIG. 2B is a schematic, cross-sectional view of a portion of the ophthalmic lens 200. The ES adhesive 206 and the WS adhesive 208 have a thickness t₁. An ES air gap 210 (e.g., the air gap between the ES lens 202 and the waveguide 100) has a distance d₁ and a WS air gap 212 (e.g., the air gap between the WS lens 204 and the waveguide 100) has a distance d₂. The air within the air gap (e.g., ES air gap 210 and WS air gap 212) prevents the light undergoing TIR in the waveguide 100 from escaping the waveguide. The distance of the air gap (e.g., ES air gap 210 and WS air gap 212) must be larger than the evanescent wave of the propagating light.

In the illustrated example, the thickness t₁ is equal to the ES air gap 210 distance d₁ and the WS air gap 212 distance d₂. A narrow bead of adhesive is desired for cosmetic reasons, such as hiding the adhesive in the glasses frame. The thickness t₁ of a narrow adhesive bead, e.g., the ES adhesive 206 and the WS adhesive 208, (and thus the distance d₁ and distance d₂) is greater than about 2 microns. However, a large ES air gap 210 and WS 212 reduces the likelihood of air gap closure during environmental thermal and pressure changes. Maintaining the air gap between the lenses and the waveguide 100 is critical to preventing disruption of the TIR utilized by the waveguide 100. Therefore, while a tall, narrow adhesive bead is desired, controlling the application of such an adhesive band is a challenge.

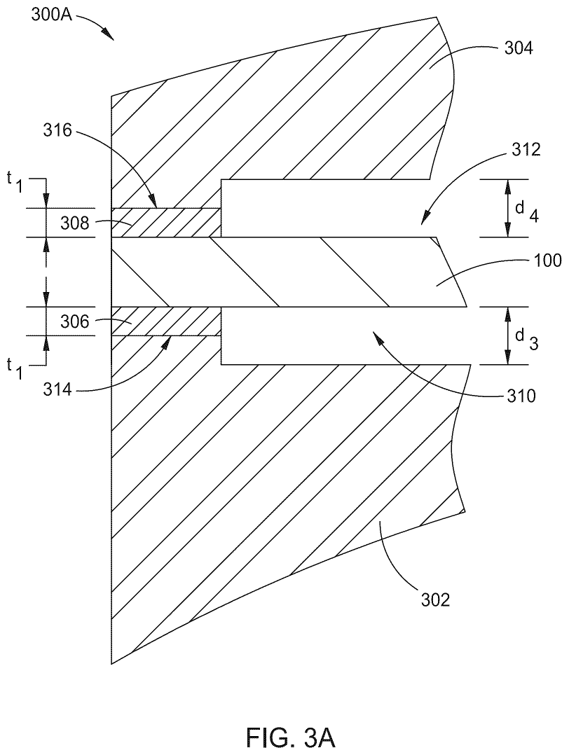

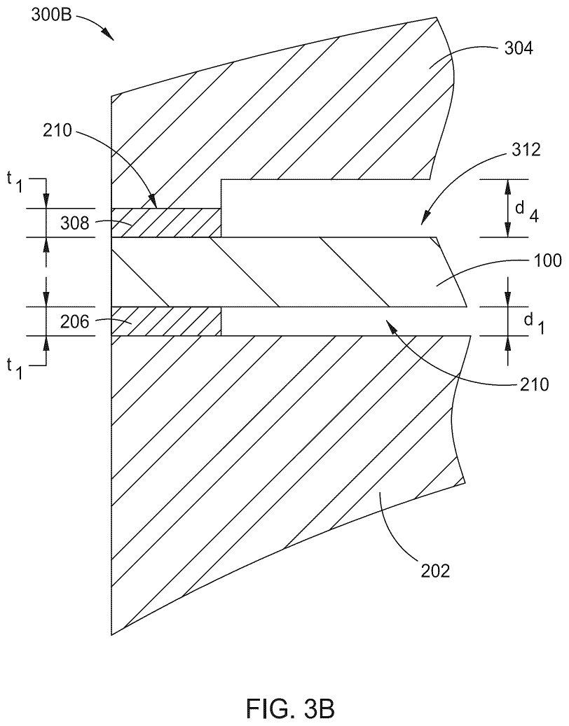

FIG. 3A is a schematic, cross-sectional view of a molded ophthalmic lens 300A including a waveguide 100. The molded ophthalmic lens 300A includes a molded ES lens 302 and a molded WS lens 304. The waveguide 100 is disposed between the molded ES lens 302 and the molded WS lens 304. A molded ES adhesive 306 secures the waveguide 100 to the molded ES lens 302, and the molded WS adhesive 308 secures the waveguide 100 to the molded WS lens 304. The molded ES adhesive 306 and the molded WS adhesive 308 have a thickness t₁. The thickness t₁ is about 50 microns to about 250 microns. A molded ES air gap 310 (e.g., the air gap between the molded ES lens 302 and the waveguide 100) has a distance d₃, and a molded WS air gap 312 (e.g., the air gap between the molded WS lens 304 and the waveguide 100) has a distance d₄. The distance d₃ and the distance de are about 50 microns to about 300 microns.

The molded ES lens 302 and the molded WS lens 304 are formed to the desired shape using a molding process, which enables the incorporation of additional features. A molded ES step 314 is formed on the molded ES lens 302, and a molded WS step 316 is formed on the molded WS lens 304. The molded ES step 314 and the molded WS step 316 enable the distance d₃ of the molded ES air gap 310 and the distance d₄ of the molded WS air gap 312 to be greater than the thickness t₁. The distance d₃ of the molded ES air gap 310 and the distance d₄ of the molded WS air gap 312 is greater than about 2 microns. The distance d₃ of the molded ES air gap 310 and the distance d₄ of the molded WS air gap 312 being greater than the thickness t₁ maintains the air gap (e.g., the molded ES air gap 310 and the molded WS air gap 312) during environmental thermal and pressure changes, thus preserving TIR.

FIG. 3B is a schematic, cross-sectional view of a partially molded ophthalmic lens 300B. In some embodiments, the molded WS lens 304 is formed using the molding process, while the ES lens 202 is a standard ophthalmic lens without any additional features. The waveguide 100 is disposed between the ES lens 202 and the molded WS lens 304. The ES adhesive 206 and the molded WS adhesive 308 have a thickness t₁. An ES air gap 210 (e.g., the air gap between the ES lens 202 and the waveguide 100) has a distance d₁.

In the illustrated embodiments, the lenses (e.g., the molded ES lens 302 and the molded WS lens 304) have a nominal plano surface, and the air gap (e.g., molded ES air gap 310 and the molded WS air gap 312 have a constant distance (e.g., d₃ and d₄). However, in other embodiments, the lenses may have an amount of curvature, thus creating an air gap with a non-constant distance between the lens and the waveguide 100. In addition, while the illustrated embodiments show a step (e.g., the molded ES step 314 and the molded WS step 316), in other embodiments, the lenses (e.g., the molded ES lens 302 and the molded WS lens 304) have a blended curvature to the adhesive (e.g., the molded ES adhesive 306 and the molded WS adhesive 308). Furthermore, while the illustrated embodiments have an adhesive material, in other embodiments a clip, a snap-fit, or other suitable mechanism may be used to couple the lenses to the waveguide 100.

In some embodiments, the WS lens (e.g., molded WS lens 304) may include a prescription, such as a progressive reading proscription, for vision correction. The molding process enables the formations of prescription lenses based on a user's potential vision impairment. The near-net shape molding process enables the formation of lenses with a range of curvatures and variable curvatures within the lenses in order to form the lenses based on the vision impairment.

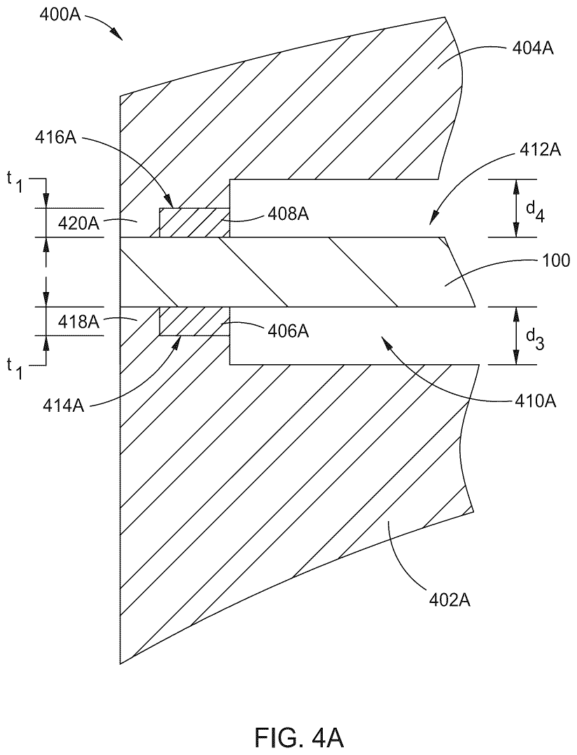

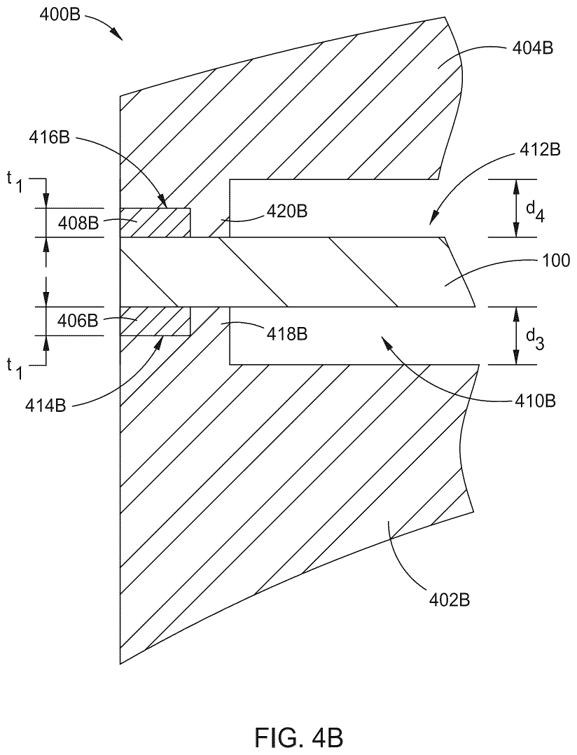

FIG. 4A is a schematic, cross-sectional view of an outer standoff ophthalmic lens 400A having outer standoffs. The outer standoff ophthalmic lens 400A includes an outer standoff ES lens 402A and an outer standoff WS lens 404A. The waveguide 100 is disposed between the outer standoff ES lens 402A and the outer standoff WS lens 404A. An outer standoff ES adhesive 406A secures the waveguide 100 to the outer standoff ES lens 402A and an outer standoff WS adhesive 408A secures the waveguide 100 to the outer standoff WS lens 404A. The outer standoff ES adhesive 406A and the outer standoff WS adhesive 408A have a thickness t₁. An outer standoff ES air gap 410A (e.g., the air gap between the outer standoff ES lens 402A and the waveguide 100) has a distance ds, and an outer standoff WS air gap 412A (e.g., the air gap between the outer standoff WS lens 404A and the waveguide 100) has a distance d₄.

The outer standoff ES lens 402A and the outer standoff WS lens 404A are formed to the desired shape using a molding process, which enables the incorporation of additional features. For example, an outer standoff ES step 414A is formed on the outer standoff ES lens 402A, and an outer standoff WS step 416A is formed on the outer standoff WS lens 404A. The outer standoff ES step 414A and the outer standoff WS step 416A enable the distance d₃ of the outer standoff ES air gap 410A and the distance d₄ of the outer standoff WS air gap 412A to be greater than the thickness t₁. As with the molded ophthalmic lens 300, the distance d₃ of the outer standoff ES air gap 410A and the distance d₄ of the outer standoff WS air gap 412A being greater than the thickness t₁ maintains the air gap (e.g., the outer standoff ES air gap 410A and the outer standoff WS air gap 412A) during environmental thermal and pressure changes, thus preserving TIR. The outer standoff ES step 414A and the outer standoff WS step 416A further include an ES outer standoff 418A and a WS outer standoff 420A. The ES outer standoff 418A and the WS outer standoff 420A are disposed at the radially outward edge of the outer standoff ES step 414A and the outer standoff WS step 416A, respectively, such that the outer standoff ES lens 402A and an outer standoff WS adhesive 408A are radially inward from the ES outer standoff 418A and the WS outer standoff 420A, respectively. The ES outer standoff 418A and the WS outer standoff 420A enable the outer standoff ophthalmic lens 400A to set the bond line thickness.

FIG. 4B is a schematic, cross-sectional view of an inner standoff ophthalmic lens 400B having inner standoffs. The inner standoff ophthalmic lens 400B includes an inner standoff ES lens 402B and an inner standoff WS lens 404B. The waveguide 100 is disposed between the inner standoff ES lens 402B and the inner standoff WS lens 404B. An inner standoff ES adhesive 406B secures the waveguide 100 to the inner standoff ES lens 402B, and an inner standoff WS adhesive 408B secures the waveguide 100 to the inner standoff WS lens 304B. The inner standoff ES adhesive 406B and the inner standoff WS adhesive 408B have a thickness t₁. An inner standoff ES air gap 410B (e.g., the air gap between the inner standoff ES lens 402B and the waveguide 100) has a distance d₃ and an inner standoff WS air gap 412B (e.g., the air gap between the inner standoff WS lens 404B and the waveguide 100) has a distance d₄.

The inner standoff ES lens 402B and the inner standoff WS lens 404B are formed to the desired shape using a molding process, which enables the incorporation of additional features. For example, an inner standoff ES step 414B is formed on the inner standoff ES lens 402B, and an inner standoff WS step 416B is formed on the inner standoff WS lens 404B. The inner standoff ES step 414B and the inner standoff WS step 416B enable the distance d₃ of the inner standoff ES air gap 410B and the distance d₄ of the inner standoff WS air gap 412B to be greater than the thickness t₁. As with the molded ophthalmic lens 300, the distance d₃ of the inner standoff ES air gap 410B and the distance d₄ of the inner standoff WS air gap 412B being greater than the thickness t₁ maintains the air gap (e.g., the inner standoff ES air gap 410B and the inner standoff WS air gap 412B) during environmental thermal and pressure changes, thus preserving TIR. The inner standoff ES step 414B and the inner standoff WS step 416B further include an ES inner standoff 418B and a WS outer standoff 420B. The ES inner standoff 418B and the WS inner standoff 420B are formed at the radially inner edge of the inner standoff ES step 414B and the inner standoff WS step 416B, respectively, such that the inner standoff ES lens 402B and an inner standoff WS adhesive 408B are radially outward from the ES inner standoff 418B and the WS inner standoff 420B, respectively. The ES inner standoff 418B and the WS inner standoff 420B enable the inner standoff ophthalmic lens 400B to set the bond line thickness.

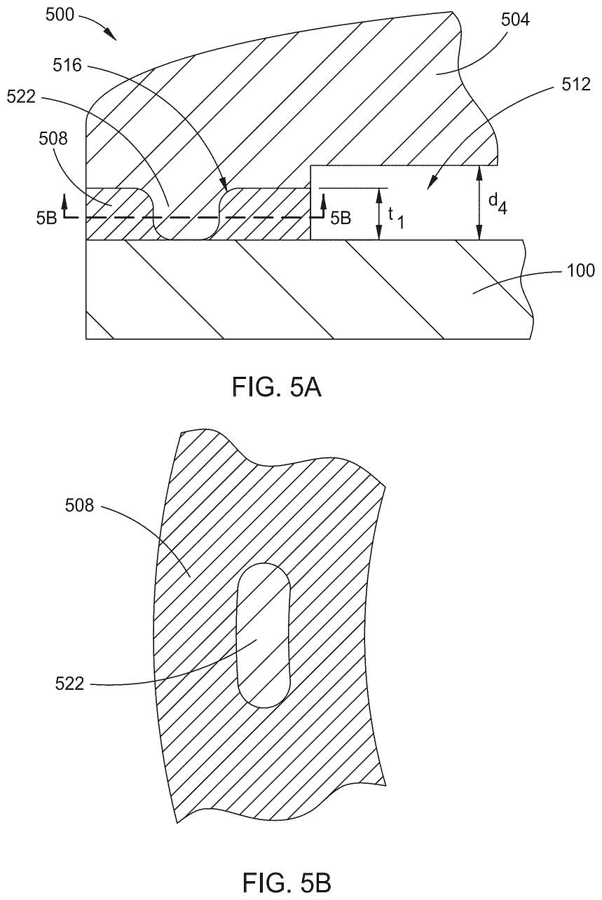

FIG. 5A is a schematic, cross-sectional view of a centered standoff ophthalmic lens 500 having centered standoffs. FIG. 5B is a schematic, cross-sectional view of the centered standoff ophthalmic lens 500 at cut line A-A. The centered standoff ophthalmic lens 500 includes a centered standoff WS lens 504. The waveguide 100 is disposed between a centered standoff ES lens (not shown) and the centered standoff WS lens 504. A centered standoff WS adhesive 508 secures the waveguide 100 to the centered standoff WS lens 504. The centered standoff WS adhesive 508 have a thickness t₁. A centered standoff WS air gap 512 (e.g., the air gap between the centered standoff WS lens 504 and the waveguide 100) has a distance d₄.

The centered standoff WS lens 504 is formed to the desired shape using a molding process, which enables the incorporation of additional features. For example, a centered standoff ES step is formed on the centered standoff WS lens 504. The centered standoff WS step 516 enables the distance d₄ of the centered standoff WS air gap 512 to be greater than the thickness t₁. As with the molded ophthalmic lens 300, the distance d₄ of the centered standoff WS air gap 512 being greater than the thickness t₁ maintains the centered standoff WS air gap 512 during environmental thermal and pressure changes, thus preserving TIR. The centered standoff WS step 516 further includes a WS centered standoff 522. The WS centered standoff 522 is formed at the radially central position of the centered standoff WS step 516, such that a portion of the centered standoff WS adhesive 508 is radially inward from the WS centered standoff 522 and a portion of the centered standoff WS adhesive 508 is radially outwardly from the WS centered standoff 522. The WS centered standoff 522 enables the centered standoff ophthalmic lens 500 to set the bond line thickness.

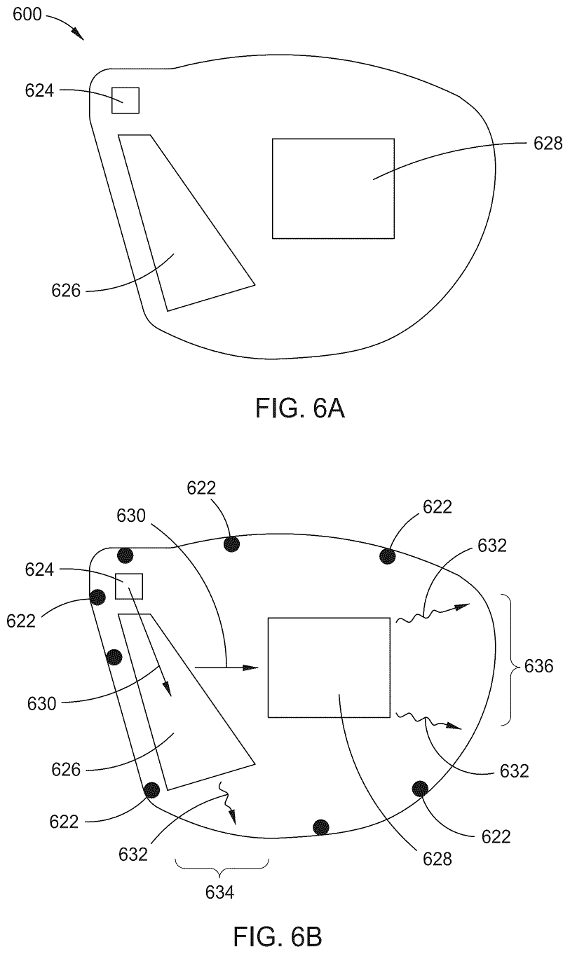

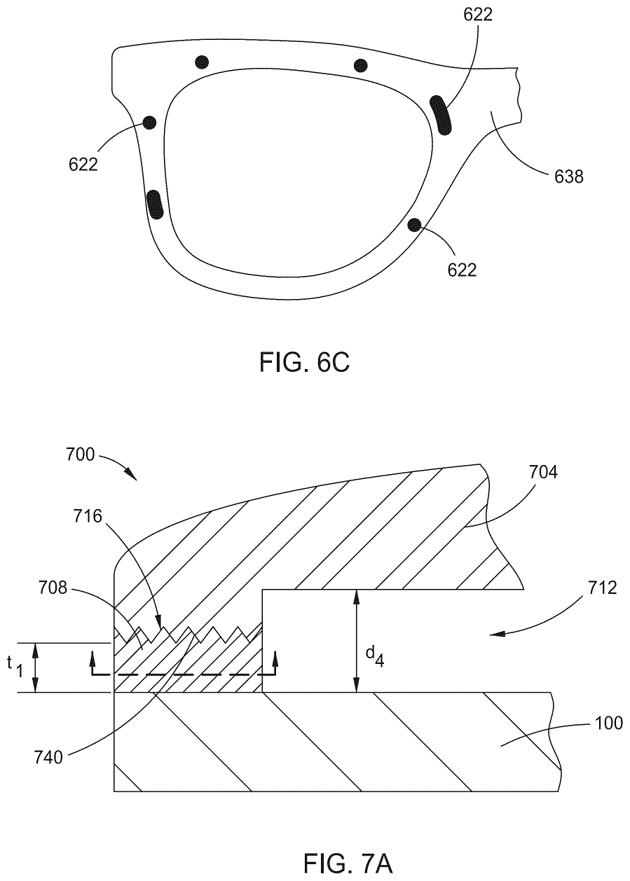

FIG. 6A is a frontal view of a standoff ophthalmic lens 600. FIG. 6B is the standoff ophthalmic lens 600 showing the travel path of a propagating light. FIG. 6C is the standoff ophthalmic lens 600 disposed in a frame 638. The standoff ophthalmic lens 600 may include the outer standoff ophthalmic lens 400A, the inner standoff ophthalmic lens 400B, or the centered standoff ophthalmic lens 500. The standoff ophthalmic lens 600 includes a first coupling region 624, a second coupling region 626, and a third coupling region 628. The propagating light includes coupled light 630 and uncoupled light 632. The coupled light 630 propagates from the first coupling region 624 to the second coupling region 626. Coupled light 630 continues from the second coupling region 626 to the third coupling region 628 while uncoupled light propagates through a first outcoupling region 634. Uncoupled light 632 propagates from the third coupling region through a second outcoupling region 636. The standoffs 622 of the standoff ophthalmic lens 600 are positioned around the standoff ophthalmic lens 600 to avoid regions in which the uncoupled light could interact with the standoffs 622, breaking TIR and therefore causing unwanted light leakage from the standoff ophthalmic lens 600. In addition, the standoffs 622 are positioned around the standoff ophthalmic lens 600 to hide the standoffs 622 in the frame 638.

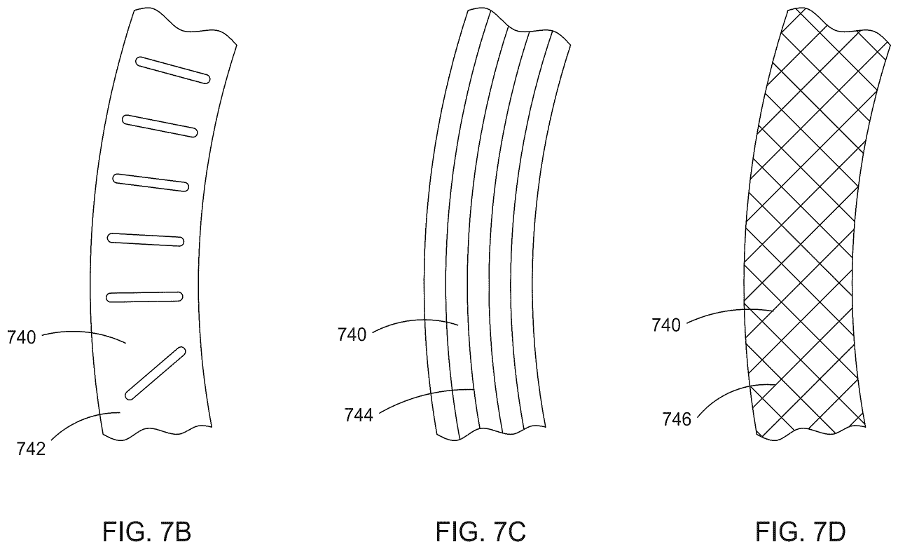

FIG. 7A is a schematic, cross-sectional view of a textured ophthalmic lens 700. The textured ophthalmic lens 700 includes a textured ES lens (not shown) and a textured WS lens 704. The waveguide 100 is disposed between the textured ES lens and the textured WS lens 704. A textured ES adhesive (not shown) secures the waveguide 100 to the textured ES lens and a textured WS adhesive 708 secures the waveguide 100 to the textured WS lens 704. The textured ES adhesive and the textured WS adhesive 708 have a thickness t₁. A textured WS air gap 712 (e.g., the air gap between the textured WS lens 704 and the waveguide 100) has a distance d₄.

The textured ES lens and the textured WS lens 704 are formed to the desired shape using a molding process, which enables the incorporation of additional features. For example, a textured ES step (not shown) is formed on the textured ES lens and a textured WS step 716 is formed on the textured WS lens 704. The textured WS step 716 enable the distance d₄ of the outer standoff WS air gap 412A to be greater than the thickness t₁. As with the molded ophthalmic lens 300, the distance d₄ of the textured WS air gap 712 being greater than the thickness t₁ maintains the air gap (e.g., the textured WS air gap 712) during environmental thermal and pressure changes, thus preserving TIR. The outer standoff ES step and the textured WS step 716 further include a texture ES feature (not shown) and a WS textured feature 740. Due to the near-net shape molding process, the perimeter of the textured ophthalmic lens 700 is known. This enables the formation of the WS textured feature 740 on the textured ophthalmic lens 700 during the near-net shape molding process. The mold used in the near-net shape molding process may include an inverse textured feature for forming the WS textured feature 740 on the textured ophthalmic lens 700.

FIG. 7B is a schematic, cross-sectional view of the textured ophthalmic lens 700 having radial features 742 at cutline B-B. FIG. 7C is a schematic, cross-sectional view of the textured ophthalmic lens 700 having circumferential features 744 at cutline B-B. FIG. 7D is a schematic, cross-sectional view of the textured ophthalmic lens 700 having roughened features 746 at cutline B-B. The ES textured feature and WS textured feature 740 enable increased adhesion between the lens (e.g., the textured ES or textured WS lens 704) and the adhesive (e.g., the textured ES adhesive or the textured WS adhesive 708).

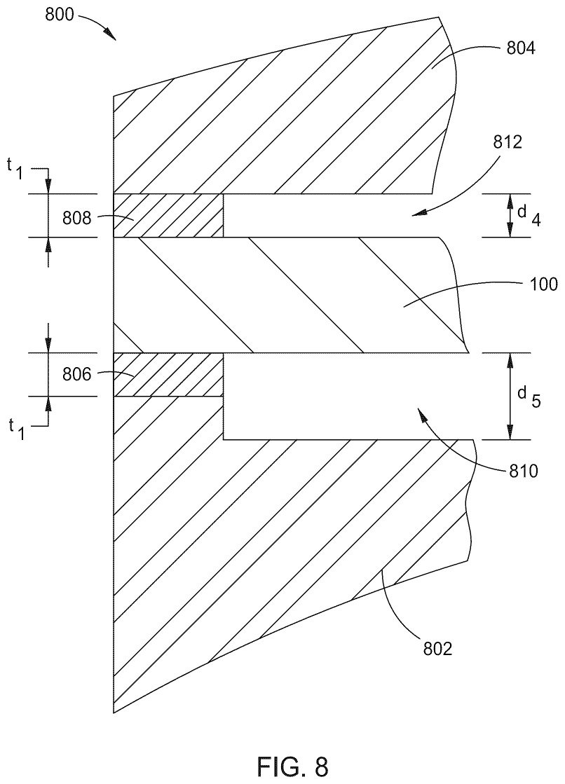

FIG. 8 is a schematic, cross-sectional view of a multi-size gap ophthalmic lens 800. The multi-size gap ophthalmic lens 800 includes first-size gap ES lens 802 and a second-size gap WS lens 804. The waveguide 100 is disposed between the first-size gap ES lens 802 and the second-size gap WS lens 804. A first-size gap ES adhesive 806 secures the waveguide 100 to the first-size gap ES lens 802 and a second-size gap WS adhesive 808 secures the waveguide 100 to the second-size gap WS lens 804. The first-size gap ES adhesive 806 and the second-size gap WS adhesive 808 have a thickness t₁. A first-size ES air gap 810 (e.g., the air gap between the first-size gap ES lens 802 and the waveguide 100) has a distance ds and a second-size gap WS air gap 812 (e.g., the air gap between the second-size gap WS lens 804 and the waveguide 100) has a distance d₄. The distance d₄ is different from the distance d₅. In some embodiments, the distance d₄ is greater than the distance d₅. In other embodiments, distance d₄ is less than the distance d₅.

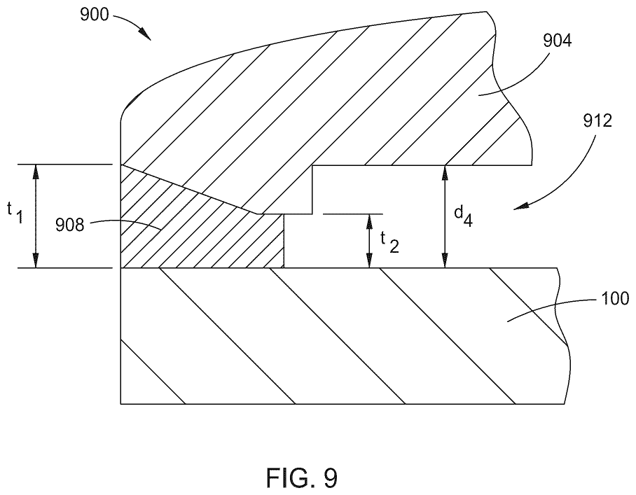

FIG. 9 is a schematic, cross-sectional view of a tapered adhesive ophthalmic lens 900. The tapered adhesive ophthalmic lens 900 includes tapered ES lens (not shown) and a tapered WS lens 904. The waveguide 100 is disposed between the tapered ES lens and the tapered WS lens 904. A tapered ES adhesive (not shown) secures the waveguide 100 to the tapered ES lens and a tapered WS adhesive 908 secures the waveguide 100 to the tapered WS lens 904. The tapered ES adhesive and the tapered WS adhesive 908 have a thickness that varies from a first thickness t₁ to a second thickness t₂. A tapered WS air gap 912 (e.g., the air gap between the tapered WS lens 904 and the waveguide 100) has a distance d₄. The first thickness t₁ is different from the second t₂. In some embodiments, the first thickness t₁ is greater than the second t₂. In other embodiments, the first thickness t₁ is less than the second t₂. In some embodiments, the tapered ES adhesive and the tapered WS adhesive 908 gradually increase or decrease from the first thickness t₁ to the second thickness t₂. In other embodiments, the tapered ES adhesive and the tapered WS adhesive 908 increase or decrease from the first thickness t₂ to the second thickness t₂ in a non-linear transition.

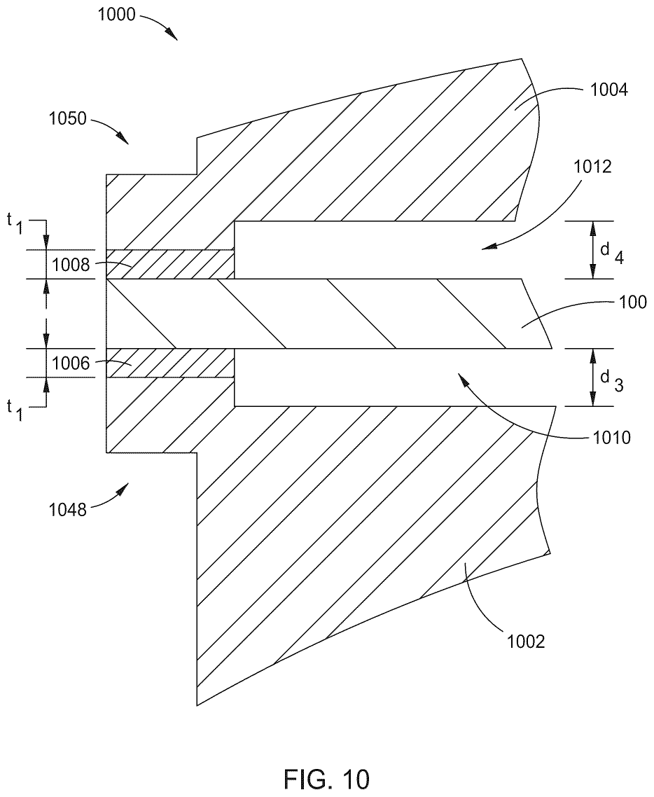

FIG. 10 is a schematic, cross-sectional view of a flanged ophthalmic lens 1000. The flanged ophthalmic lens 1000 includes a flanged ES lens 1002 and a flanged WS lens 1004. The waveguide 100 is disposed between the flanged ES lens 1002 and the flanged WS lens 1004. A flanged ES adhesive 1006 secures the waveguide 100 to the flanged ES lens 1002 and a flanged WS adhesive 1008 secures the waveguide 100 to the flanged WS lens 1004. The flanged ES adhesive 1006 and the flanged WS adhesive 1008 have a thickness t₁. A flanged ES air gap 1010 (e.g., the air gap between the flanged ES lens 1002 and the waveguide 100) has a distance d₃ and a flanged WS air gap 1012 (e.g., the air gap between the flanged WS lens 1004 and the waveguide 100) has a distance d₄.

The flanged ES lens 1002 and the flanged WS lens 1004 are formed to the desired shape using a molding process, which enables the incorporation of additional features. For example, an ES flange 1048 is formed at a radially outward edge of the flanged ES lens 1002 and a WS flange 1050 is formed at the radially outward edge of the flanged WS lens 1004. The ES flange 1048 and the WS flange 1050 enable more efficient integration of the flanged ES lens 1002 and the flanged WS lens 1004 into a frame, such as frame 638.

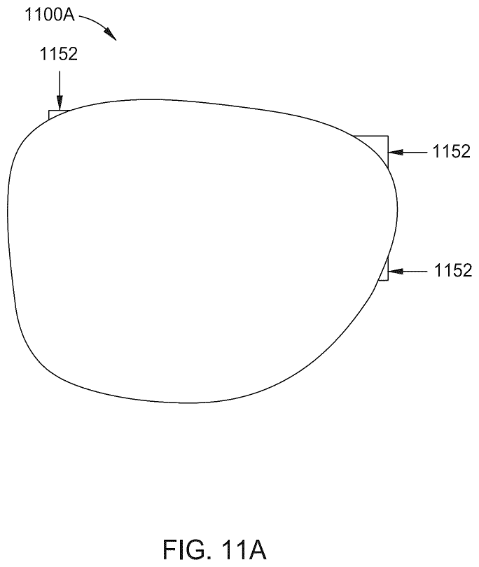

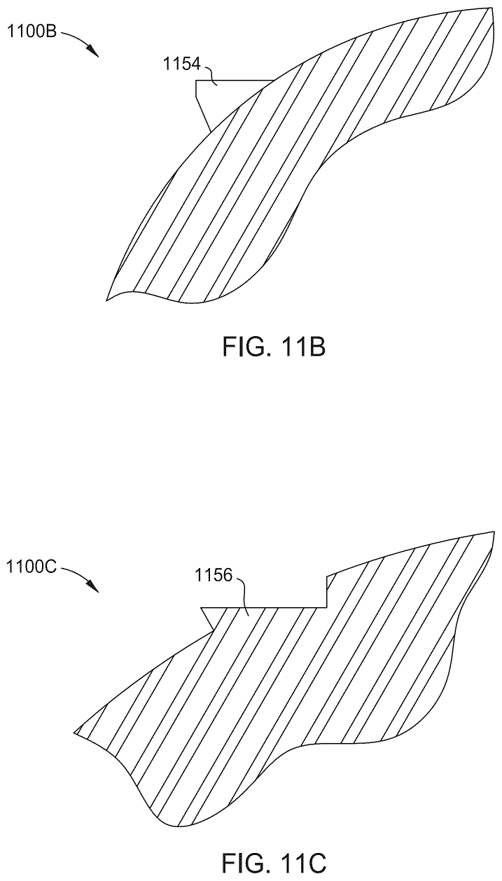

FIG. 11A is a schematic, frontal view of a datum ophthalmic lens 1100A having a plurality of datums 1152. FIG. 11B is a schematic view of a portion of the datum ophthalmic lens 1100B having a first datum 1154. FIG. 11C is a schematic view of a portion of the datum ophthalmic lens 1100C having a second datum 1156. The plurality of datums 1152 may be the first datum 1154 or the second datum 1156. The datum ophthalmic lens 1100A is formed to the desired shape using a molding process, which enables the incorporation of additional features, such as the first datum 1154 or the second datum 1156. The molding process enables sharp corners, which enables the formation of smaller datums 1152. The size of plurality of datums 1152 are not limited by the cutting radius of the edging tool. In addition, the use of molding tools with side action enables more feature capability.

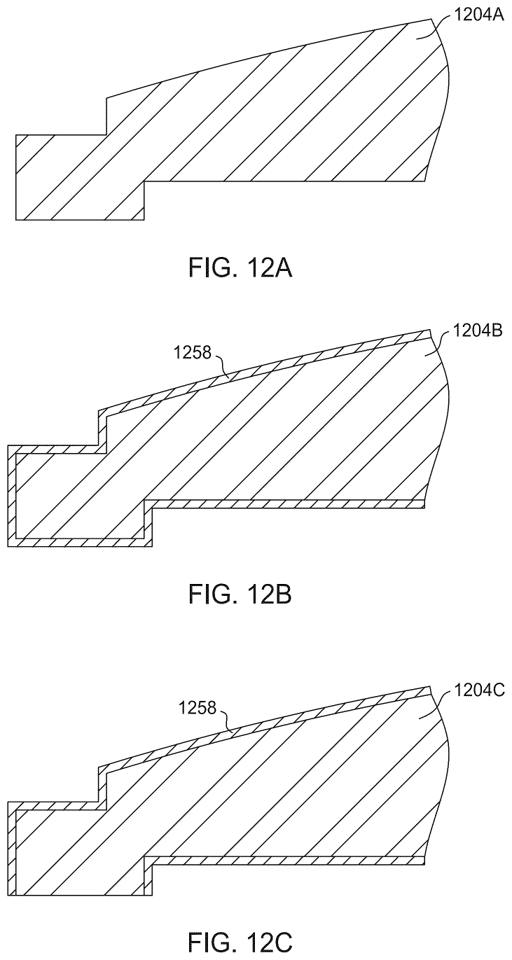

FIG. 12A is a schematic, cross-sectional view of an uncoated WS lens 1204A. FIG. 12B is a schematic, cross-sectional view of a coated WS lens 1204B. FIG. 12C is a schematic, cross-sectional view of a machined WS lens 1204C. Typically, an ophthalmic lens (such as the uncoated WS lens 1204A) are coated using a dip coating procedure to form a coating around the ophthalmic lens (such as the coating 1258 surrounding the coated WS lens 1204B). The coating 1258 may be a protective coating, a coating to promote visual clarity, or a fog resistance coating, a UV light blocking coating, a tintable coating, a high-index matched coating, a chemical coating, or other suitable coating. The dip coating procedure requires the WS adhesive to bond to the coating 1258 to form the ophthalmic lens. The near-net shape molding process enables selective removal of regions of the coating 1258 using post-coating machining/edging. The near-net shape molding process enables the selective removal of the coating 1258 such that the post-coating/chining/edging reduces cycle time, reduces material waste, and enables external features to be molded and used for locating/positioning and then removed during the machining/edging.

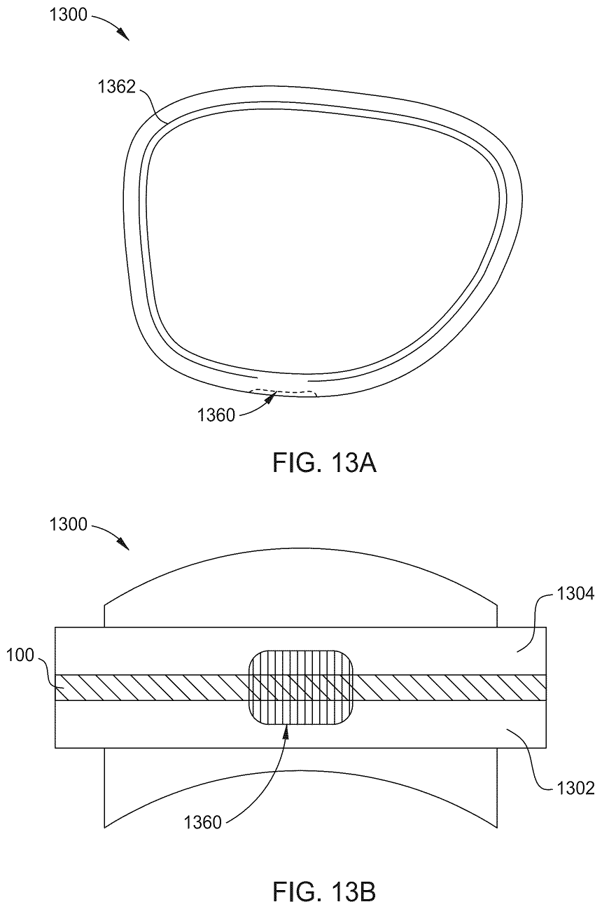

FIG. 13A is a schematic, frontal view of a vented ophthalmic lens 1300. FIG. 13B is a schematic, bottom view of the vented ophthalmic lens 1300. The vented ophthalmic lens 1300 includes a vented ES lens 1302, a vented WS lens 1304, the waveguide 100, a membrane vent 1360, and a vented adhesive 1362. In some embodiments, the membrane vent 1360 is an expanded polytetrafluoroethylene (ePTFE) vent. The membrane vent 1360 enables moisture control in the air gap (e.g., the WS air gap or the ES air gap) to prevent condensation between the lens (e.g., the WS lens or the ES lens) and the waveguide 100. In addition, the near-net shape molding of the vented ophthalmic lens 1300 enables additional features for placement of the membrane vent 1360.

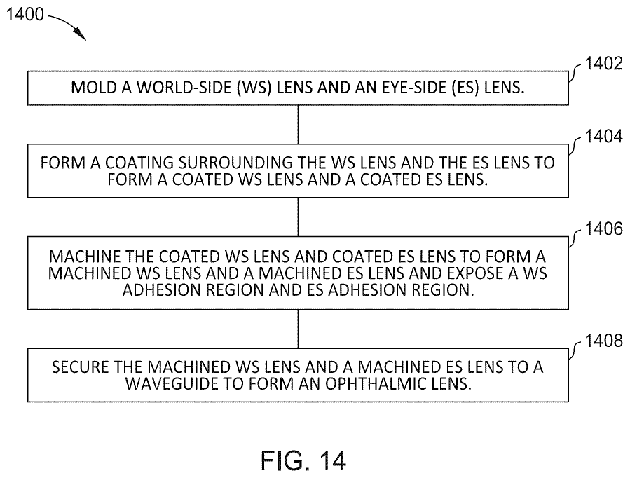

FIG. 14 is a flow chart of a method 1400 of forming an ophthalmic lens. The method 1400 can be used to form the molded ophthalmic lens 300, the outer standoff ophthalmic lens 400A, the inner standoff ophthalmic lens 400B, the centered standoff ophthalmic lens 500, the standoff ophthalmic lens 600, the textured ophthalmic lens 700, the multi-size gap ophthalmic lens 800, the tapered adhesive ophthalmic lens 900, the flanged ophthalmic lens 1000, the datum ophthalmic lens 1100, or the vented ophthalmic lens 1300. At operation 1402, a world-side (WS) lens and an eye-side (ES) lens are molded. The molding process is a near-net shape molding process. The near-net shaped molding process enables the formation of features on the lens, such as standoffs, textured features, datums, flanges, steps, and membrane vents. In addition, the near-net shape molding is may be performed using processing methods, such as casting or 3D printing.

At operation 1404, a coating is formed surrounding the WS lens and the ES lens to form a coated WS lens and a coated ES lens. The coating may include a protective coating, a coating to promote visual clarity, or a fog resistance coating, a UV light blocking coating, a tintable coating, a high-index matched coating, a chemical coating, or other suitable coating.

At operation 1406, the coated WS lens and the coated ES lens are machined to expose a WS adhesion region and an ES adhesion region, respectively. Machining the coated WS lens and the coated ES lens forms a machined WS lens and a machined ES lens. The WS adhesion region is positioned at a radially outward edge of the machined WS lens and the ES adhesion region is positioned at a radially outward edge of the machined ES lens. In some embodiments, the WS adhesion regions is formed on a WS step and the ES adhesion region is formed on an ES step. The WS step and the ES step were formed during the molding process.

At operation 1408, the machined WS lens and the machined ES lens are secured to a waveguide to form the ophthalmic lens. The machined WS lens and the machined ES lens are secured to the waveguide at the WS adhesion region and the ES adhesion region, respectively. The WS lens and the ES lens are secured to the waveguide using an adhesive, a clip, a snap-fit, or other suitable mechanism.

In summary, a near-net molded ophthalmic lens is a lens. The near-net molded ophthalmic lens enables the incorporation of additional features, such as a standoff, a texture, a taper, multi-sized gaps, datums, flanges, vents, or other suitable features.

While the foregoing is directed to embodiments of the present disclosure, other and further embodiments of the disclosure may be devised without departing from the basic scope thereof, and the scope thereof is determined by the claims that follow.

What is claimed is:

1. An ophthalmic lens comprising:
a waveguide;
a world-side (WS) lens;
a WS adhesive securing the WS lens to the waveguide, the WS adhesive having a WS thickness;
a WS air gap between the WS lens and the waveguide, the WS air gap having a WS air gap distance, wherein the WS air gap distance is greater than the WS adhesive thickness;
an eye-side(ES) lens;
an ES adhesive securing the ES lens to the waveguide, the ES adhesive having an ES thickness; and
an ES air gap between the ES lens and the waveguide, the ES air gap having an ES air gap distance, wherein the ES air gap distance is greater than the ES adhesive thickness.

2. The ophthalmic lens of claim 1, wherein each of the ES air gap and the WS air gap has an air gap distance of about 50 microns to about 300 microns.

3. The ophthalmic lens of claim 1, wherein each of the ES adhesive and the WS adhesive has an adhesive thickness of about 50 microns to about 250 microns.

4. The ophthalmic lens of claim 1, wherein:
the ES air gap has an ES air gap distance; and
the WS air gap has a WS air gap distance, wherein the ES air gap distance is different from the WS air gap distance.

5. The ophthalmic lens of claim 1, wherein:
the WS lens includes a WS step comprising a WS textured feature; and
the ES lens includes an ES step.

6. The ophthalmic lens of claim 5, wherein the WS textured feature includes a radial feature, a circumferential features, or a roughened feature.

7. The ophthalmic lens of claim 5, wherein:
the ES step includes an ES textured feature, wherein the ES textured feature includes a radial feature, a circumferential features, or a roughened feature.

8. An ophthalmic lens, comprising
a waveguide comprising a plurality of optical devices;
a world-side (WS) lens;
a WS adhesive securing the WS lens to the waveguide, the WS adhesive having a WS adhesive thickness, the WS adhesive having an WS adhesive thickness of about 50 microns to about 250 microns.
a WS air gap between the WS lens and the waveguide, the WS air gap having a WS air gap distance of about 50 microns to about 300 microns;
an eye-side (ES) lens;
an ES adhesive securing the ES lens to the waveguide, the ES adhesive having an ES adhesive thickness of about 50 microns to about 250 microns; and
an ES air gap between the ES lens and the waveguide, the ES air gap having an ES air gap distance of about 50 microns to about 300 microns.

9. The ophthalmic lens of claim 8, wherein:
the WS lens includes a WS step, the WS step including a WS standoff; and
the ES lens includes an ES step, the ES step including an ES standoff.

10. The ophthalmic lens of claim 9, wherein:
the WS standoff is disposed at a radially outward edge of the WS step such that the WS adhesive is radially inward from the WS step; and
the ES standoff is disposed at a radially outward edge of the ES step such that the ES adhesive is radially inward from the ES step.

11. The ophthalmic lens of claim 9, wherein:
the WS standoff is disposed at a radially inward edge of the WS step such that the WS adhesive is radially outward from the WS step; and
the ES standoff is disposed at a radially inward edge of the ES step such that the ES adhesive is radially outward from the ES step.

12. The ophthalmic lens of claim 9, wherein the WS adhesive thickness has a first thickness at a radially outward edge of the WS step and a second thickness at a radially inward edge of the WS step.

13. The ophthalmic lens of claim 8, wherein:
the WS lens has a WS flange formed at a radially outward edge of the WS lens; and
the ES lens has an ES flange formed at a radially outward edge of the ES lens.

14. The ophthalmic lens of claim 8, further comprising a membrane vent.

15. A method of forming an ophthalmic lens, comprising:
molding a world-side (WS) lens and an eye-side(ES) lens;
forming a coating around the WS lens and the ES lens to form a coated WS lens and a coated ES lens;
machining the coated WS lens and the coated ES lens to form a machined WS lens having a WS adhesion region and a machined ES lens having an ES adhesion region; and
securing the machined WS lens and the machined ES lens to a waveguide at the WS adhesion region and the ES adhesion region.

16. The method of claim 15, wherein the machined WS lens and the machined ES lens are secured to the waveguide using an adhesive, a clip, or a snap-fit mechanism.

17. The method of claim 15, wherein the coating comprises a protective coating, a coating to promote visual clarity, a fog resistance coating, a UV light blocking coating, a tintable coating, a high-index matched coating, or a chemical coating.

18. The method of claim 15, wherein molding the WS lens and ES lens further comprises forming a feature on the WS lens.

19. The method of claim 18, wherein molding the WS lens and ES lens further comprises forming a feature on the ES lens.

20. The method of claim 19, wherein the feature comprises standoffs, textured features, datums, flanges, steps, and membrane vents.
